(19) United States
(12) Patent Application Publication
(10) Pub. No.: US 2015/0373814 A1
(43) Pub. Date: Dec. 24, 2015

(54) FACILITY LIGHTING CONTROL SYSTEM

(71) Applicant: Howard Industries, Inc., Ellisville, MS (US)

(72) Inventors: Marshall Claude Inzer, Birmingham, AL (US); Michael Chandler Rochester, Birmingham, AL (US)

(21) Appl. No.: 14/726,138

(22) Filed: May 29, 2015

Related U.S. Application Data
(60) Provisional application No. 62/005,727, filed on May 30, 2014.

(51) Int. Cl. H05B 37/02; G06Q 20/34; G06Q 20/32; G06Q 20/24

(52) U.S. Cl. CPC H05B 37/0272; G06Q 20/24; G06Q 20/34; G06Q 20/325

(57) ABSTRACT

A lighting control system for municipalities and recreation departments is disclosed. The lighting system can process payments so that a user can pay for usage of a recreational facility at the time of need. The lighting control system can communicate with remote systems such that only a single cellular connection or broadband connection is required.

### CROSS-REFERENCES TO RELATED APPLICATIONS

This application claims the benefit of U.S. Provisional Application No. 62,005,727, filed May 30, 2014, which is incorporated herein by reference in its entirety.

### FIELD OF THE INVENTION

The present invention is generally directed toward a system for controlling a lighting system for a recreational facility.

### BACKGROUND OF THE INVENTION

Lighting control systems are used to assist parks and recreation departments and other municipality departments with monitoring, regulating, and charging for usage of parks, tennis courts, and other recreational facilities. The systems that are currently available require a cellular broadband connection or interne connection to communicate at each of the parks. As a result, the costs of operating the system can be high.

Other known systems require the user to log on to a specific website to make changes to schedules, override and monitor their own facilities, but typically do not allow for public based access for local, remote or “pay for play.” The current technology requires that each controller in a facility that requires multiple control units have cellular communications at each controller to communicate with the system.

### SUMMARY OF THE INVENTION

The presently disclosed system is a sports lighting control system designed to allow the facilities operator to recover revenue by using Debit/Credit Cards, Prepaid Card, or a purchased key code. It allows the facilities operator to recover some or all of the cost for field maintenance and power usage from sports lighting from pay-for-play in which the user of the facility pays in advance for the time that they wish to use it. The control system also functions to control time of day and unauthorized usage. The more advanced system is designed to notify the owner of usage outside of the normal operating hours via email or text messaging. The system is designed for use at baseball, softball, football, soccer, and tennis facilities and can also be used to control all aspects of lighting within a park including parking lots and walking trails.

### BRIEF DESCRIPTION OF THE DRAWINGS

Further advantages of the invention will become apparent by reference to the detailed description of preferred embodiments when considered in conjunction with the drawings:

FIG. 1 depicts a block diagram of the controller processes performed by a stand-alone embodiment of the invention.

FIG. 2 depicts a block diagram of the controller processes performed by an embodiment of the invention that serves as the host controller.

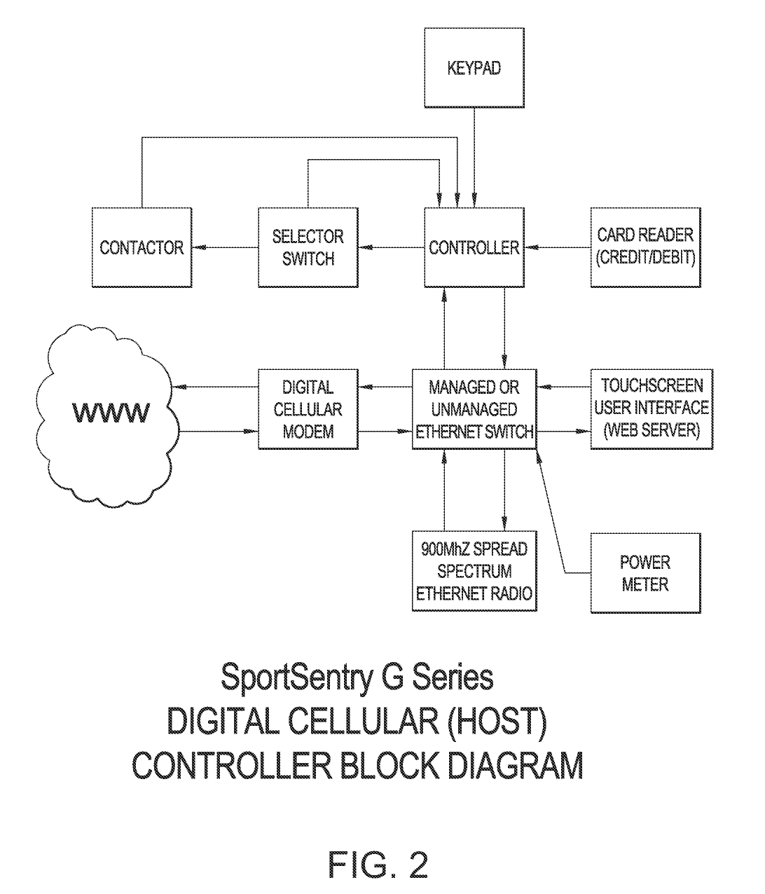

FIG. 3 depicts a block diagram of the controller processes performed by an embodiment of the invention that serves as the remote.

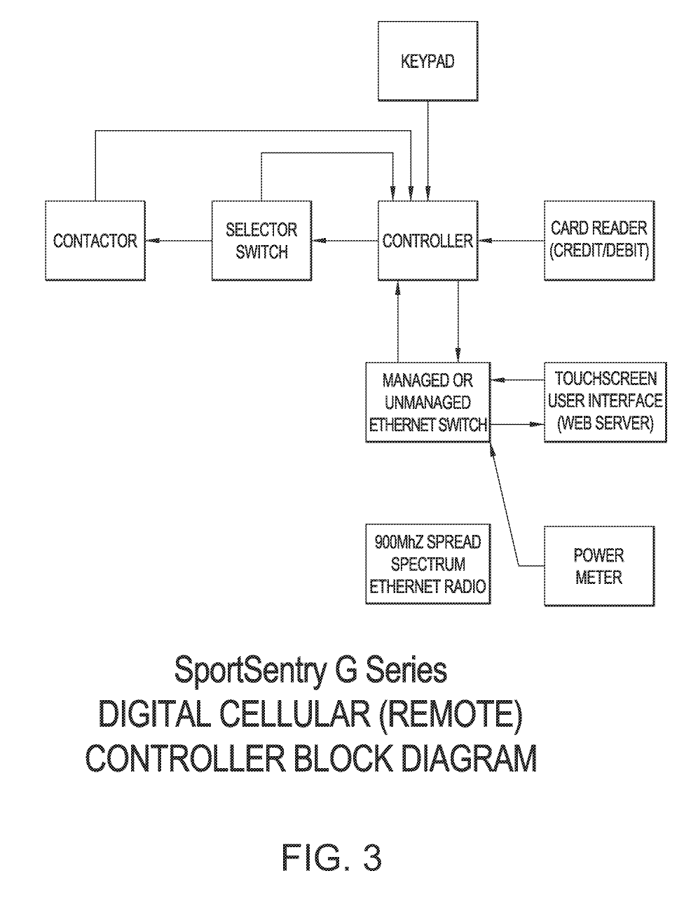

FIG. 4 depicts the front of various embodiments of control boxes.

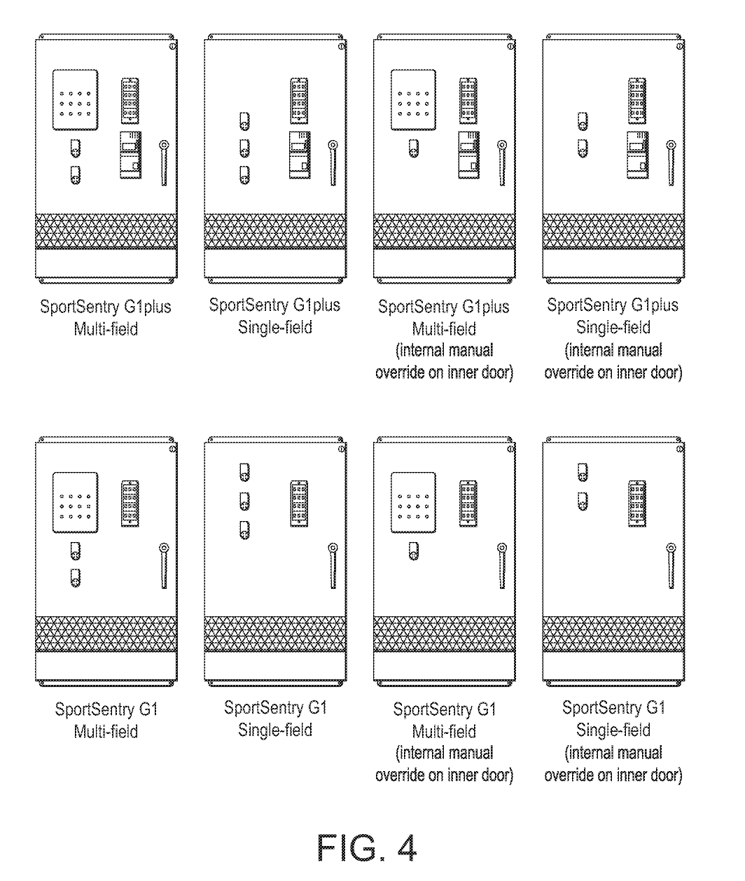

FIG. 5 depicts additional front of various embodiments of control boxes.

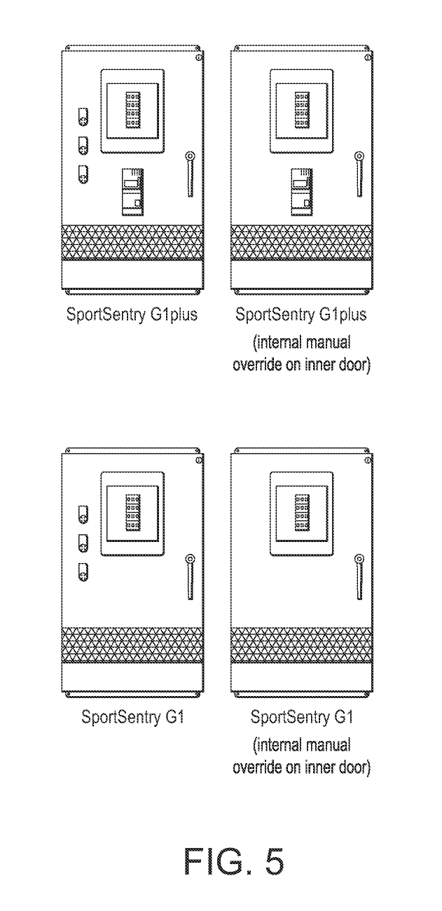

FIG. 6 depicts a block diagram of the controller processes performed by an embodiment of the invention that serves as the remote.

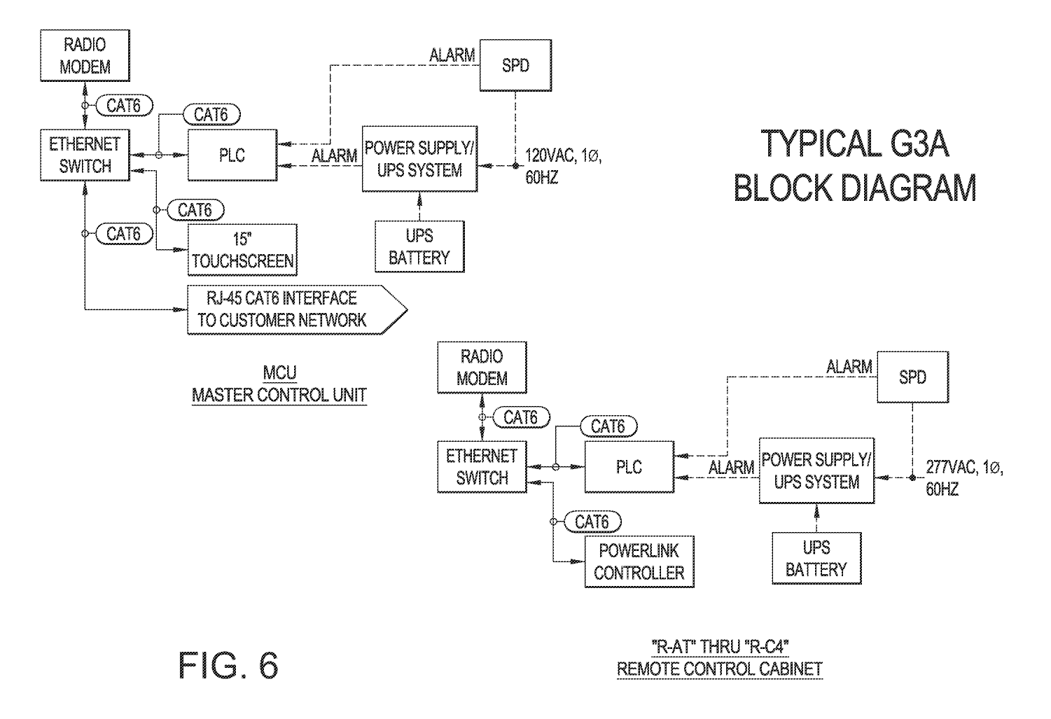

FIG. 7 depicts a configuration diagram of an embodiment of the invention.

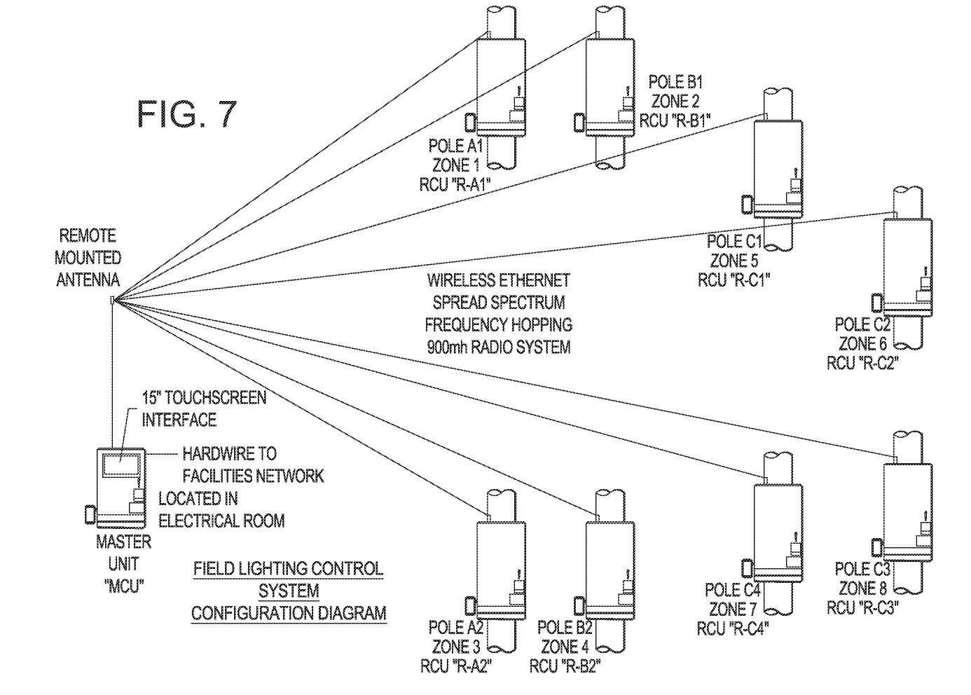

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The invention claimed herein allows both facilities operator and the public to access the interface, and does not require an internet connection except for processing payments where desired. Furthermore, it does not require an internet connection to accomplish schedule changes, or to monitor and control or to perform maintenance at the local level.

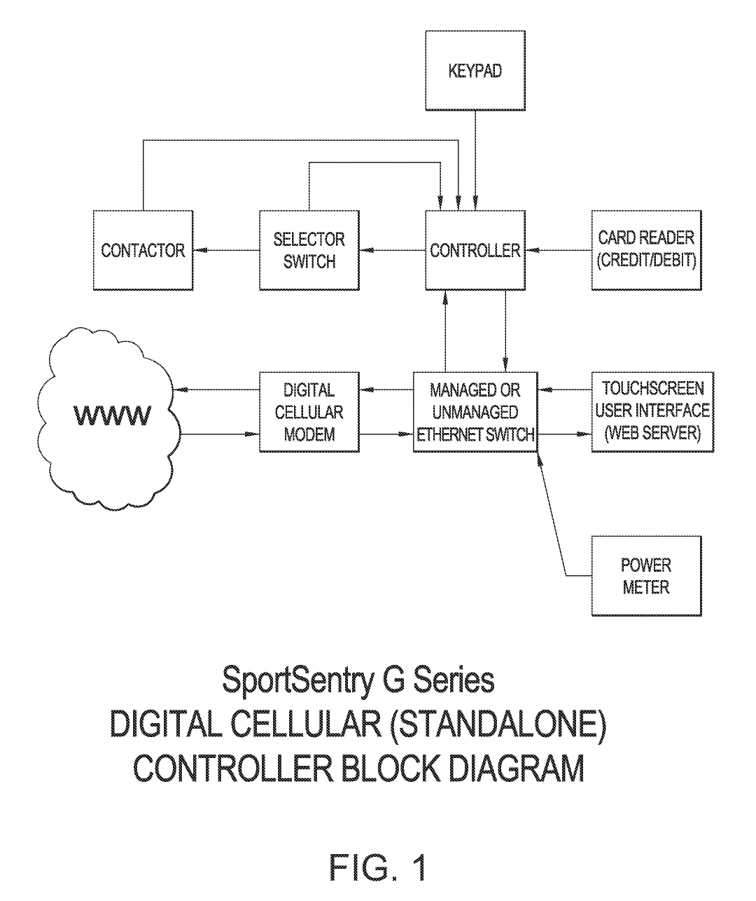

The claimed invention allows a user of the facilities to pay in advance for the time that they wish to use the facilities. In one embodiment, the controller transmits the credit card information over its internal cellular data connection. However, if an existing customer broadband network is available (either hardwired or wireless), the controller can utilize that to transmit data, thus eliminating the need for expensive cellular data usage plans. FIG. 1 depicts a block diagram for such a stand-alone system.

In another embodiment, multiple controllers can be linked together to transmit data between each other. To accomplish this, one controller, the host, will have access to the internet or outside payment processing facility through a digital cellular network. Additionally, the host controller will have a radio transmitter, preferably a 900 MHz Spread Spectrum radio, with which it can communicate with remote controllers. The remote controllers can then transmit data, including payment processing data, to the host controller which will then in turn transmit that data over its cellular or broadband connection. For example, the claimed invention can provide 900 MHz radio communications between controllers located in the same facility and can provide complete 900 MHz communications between different facilities if required. The system is also configured to allow the user to add zones to a controller by adding the required hardware (contactor or relay) and selecting the additional number required (up to 8) through the software without the need for manufacturer involvement. As will be appreciated, by sharing communications, the remote controllers can relay information from other distant remote controllers that would otherwise be out of range of cellular signals.

The disclosed control system employs a state-of-the-art programmable micro-processor based control unit that is simple to use and operate. The programmable control unit allows the facility operator to make changes in time and functionality. By the use of a keypad, card swipe, touchscreen interface or combination thereof, the facility operator can control the lighting for an individual field for practice or play and will automatically turn off the lights after a predetermined time. In addition to the standard control options, the disclosed system is designed to ensure that lighting is not turned off while people are exiting the field. Prior to turning off the lights the system will warn anyone still on the field that the lights will be turning off in 15, 10 and 5 minute intervals. The “Safe Egress” feature allows players to exit the field without being surprised by the lights being turned off.

The disclosed system is expandable and can be incorporated into the G3 by just adding the components needed. The local field unit can be upgraded from a simple keypad operation to a Debit/Credit Card kiosk by removing the keypad and installing the e-Port Card Reader and wireless hardware to the existing unit. The Debit/Credit Card option can also be added to the unit without removing the keypad for both operations.

The disclosed system is custom engineered, allowing more flexibility for the end user. For example, “Scheduling” changes can be done on the fly by the user without calling, faxing, or emailing a third party. Instead, it is as simple as accessing the schedule from the local user interface or a PC (through a secure web browser), entering a password and changing the schedule.

It should be appreciated that the system can also prepare reports that are useful in maintenance of the fields. For example, lamp life and energy usage reports can be printed from any PC with internet access and the right credentials. Lights can be turned OFF or ON and system status viewed using a PC, Laptop, Smartphone or local user interface. All remote access is done through a WEB Browser (i.e., Internet Explorer, Safari, etc.) and does not require any programs to be loaded on to a PC, Tablet or Smartphone.

Usage of the system by a park user can be as simple as selecting the amount of time that the user would like the lights to be on and swiping a credit card to pay for the usage. The lights would then come on for the prescribed time. Prior to the end of the period, the user would be warned that the lights will turn off.

One embodiment, marketed as the SportSentry G3 Series RLCS, is a state-of-the-art automated sports lighting control system. The G3 employs industry proven and commercially available hardware and software to provide one of the markets most robust and user friendly system on the market today. The G3 series feature reach software package is customized for the user with the user.

This embodiment is a conventional type system with contactors and controller in a single package. The G3 is provided standard with a local 7.5″ (up to 19″ available) Color Touchscreen display, SportsView software package and local manual override switches and does not require remote access for scheduling, monitoring and control. The G3 iSportsView for smart mobile devices, including but not limited to, iPads and iPhones is also available. The G3 offers digital cellular interface, and can be directly connected to a customer's existing broadband network to provide Internet access and control from any computer with web access, thus saving the customer money by eliminating the need for a cellular plan. The G3 offers wireless in park communications using 900 MHz Frequency hopping Spread Spectrum radios which eliminates the need for separate cellular wireless units to be placed at each location. As a basic feature of the G3, the user interface can be located separate from the contactor cabinets adding safety and convenience for the customer.

Another embodiment known as the G3 Advantage or G3A provides the same functionality as the G3 except for it eliminates the need for contactors and panel boards by using remote operated breakers (up to 30A 3 Phase) and controls in a single cabinet.

The embodiments may be controlled by software known as SportsView 2.0. It is the most powerful and easy-to-use user interface on the market today to control the facility lighting system. It works with the SportSentry G3 Systems Graphic HMI provided with all G3 SportSentry Units. The SportsView 2.0 software is highly functional with a user friendly touchscreen interface for sports lighting applications.

Although monitoring and controlling your sports lighting from a tropical island sounds exciting and fun, from a practical business standpoint it does always work that way. The SportSentry G3 SportsView 2.0 and HMI combination offers both remote and local control and monitoring. Specifically, managers and supervisors can operate several ballparks at the same time. The manager can monitor his lamp usage and alarms from his office. The head of maintenance can predict lamp replacements and monitor alarms such as unauthorized access and usage from his office complex . The internal VNC server in the G3 HMI is included. Similarly, users can access the system at once over the internet.

G3 HMI has a built in webserver that allows it to be remotely controlled and monitored with laptops, desktop PCs, iPhones, iPads or any other device that has a VNC client capability.

This remote monitoring and control provides logistical improvements in the control of facilities. The improvements include decreasing energy cost by positively controlling the usage of each facility.

The system including a password feature that secures a facility and prevents it from being modified without the proper password. A unique password can be assigned to any park employee that will cause the system to run only in specific modes that have a matching password. This allows for limited control such as manual “OVERRIDE” for extended play.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A lighting control system for municipalities comprising:
a. a means for activating a lighting system;
b. a controller for accessing payment processing systems;
c. a credit card reader; and
d. a broadband or cellular connection.

2. The device of claim 1 further comprising:
a. a radio for communication with a remote control module.

3. A system for controlling lighting at multiple locations by a user comprising:
a. a host controller having a radio capable of communicating with a remote controller and a network connection to the internet; and
b. at least one remote controller having a radio in communication with a host controller and capable of controlling lighting at the remote location.

4. The device of claim 3 wherein said network connection to the internet is broadband.

5. The device of claim 3 wherein said network connection to the internet is cellular data.

6. The device of claim 3 wherein said host controller also has a credit card reader. The device of claim 3 wherein said system uses remote operated breakers.

7. The device of claim 3 wherein said system is controlled by software.
